(19) United States
(12) Patent Application Publication
(10) Pub. No.: US 2002/0125460 A1
(43) Pub. Date: Sep. 12, 2002

(54) Compositions for chemical mechanical planarization of tungsten

(76) Inventor: Bruce Tredinnick, Surprise, AZ (US)

Correspondence Address: George Wolken Jr., SKJERVEN MORRILL MacPHERSON LLP, 25 Metro Drive, Suite 700, San Jose, CA, 95110-1349, US

(21) Appl. No.: 09/757,559

(22) Filed: Jan. 9, 2001

(51) Int. Cl. H01B 3/48; C09K 13/00; C09K 13/08

(52) U.S. Cl. 252/79.1; 252/79.2; 252/79.3; 252/567; 252/570

(57) ABSTRACT

The present invention relates to slurry compositions for the chemical mechanical planarization (“CMP”) of tungsten. A non-metallic oxidizer in the form of periodic acid is used in combination with a mineral acid typically nitric acid, to maintain the pH of periodic acid at levels not leading to the precipitation of iodic acid salts. Ammonium nitrate (NH₄NO₃) is included in the CMP slurry which yields soft pad polishing rates of tungsten film removal of approximately 4,000 Å/min.

### BACKGROUND OF THE INVENTION

1. Technical Field

The present invention relates to the general field of planarization of surfaces in the manufacture of integrated circuits and, in particular, to compositions for the chemical mechanical planarization of tungsten and for the removal of tungsten, titanium and titanium nitride layers.

2. Description of Related Art

Modem designs for integrated circuits (“ICs”) typically consist of multiple layers of material into which patterns are etched. IC's consist of multiple layers of conducting, insulating and semiconductor materials, interconnected in various ways by conducting metallic channels and plugs (“vias”), including various dopants implanted into various materials for producing the electronic functionality desired of the IC. Present IC technology typically makes use of tungsten (W) and aluminum (Al) as conductors. Both materials have adequate electrical conductivity for present IC devices.

The near-universal trend in the manufacture of integrated circuits is to increase the density of components fabricated onto a given area of wafer, increase the performance and reliability of the ICs, and to manufacture the ICs at lower cost with less waste and fewer defective products generated by the manufacturing process. These goals lead to more stringent geometric and dimensional requirements in the manufacturing process. In particular, etching precise patterns into a layer is facilitated by the layer having a surface as nearly planar as feasible at the start of the patterning process. For the common case of patterning by means of photolithography, a planar surface permits more precise location and dimensioning for focusing the incident radiation onto the surface to be etched than would be possible with a surface having deviations from planarity. Similar conclusions typically apply for electron beam or other means of etching. That is, deviations from planarity of the surface to be etched reduce the ability of the surface to support precisely positioned and precisely dimensioned etches. In the following description of the present invention we focus on the typical etching, planarization and photolithography processes as practiced in the manufacture of ICs.

Techniques for manufacturing ICs include dielectric planarization and recessed metal (or damascene) planarization as described, for example, by Gregory B. Shinn et. al. “Chemical-Mechanical Polish,” in Handbook of Semiconductor Manufacturing Technology, Ed. Y. Nishi and R. Doering (Marcel Dekker, Inc. 2000), pp. 415-460. “Damascene” or “dual damascene” processing typically proceeds by depositing a blanket layer of metal on top of a patterned insulating or dielectric layer, thereby filling channels and vias in the patterned insulating layer. When necessary, the metal deposition is preceded by the deposit of a barrier or adhesion layer between the metal and the dielectric. Since trench and via filling is not typically uniform, the metal is deposited to fill the features and covers the field regions between features as well. This blanket metal overlayer is then typically removed by chemical mechanical planarization or etching, revealing the inlaid metal channels and vias with a surface ideally coplanar with the field regions of the surrounding dielectric. The barrier layer on the field region is also typically removed in the planarization step. Dual damascene is a two-step damascene process, typically forming more than one layer of features in the dielectric before barrier layer and metal are deposited.

Chemical Mechanical Planarization (“CMP”) has been successfully integrated into integrated circuit multilayer manufacturing processes to achieve highly planar surfaces as described in text books (for example, “Microchip Fabrication” by Peter Van Zant, 3rd Ed., 1997 and “Chemical Mechanical Planarization of Microelectronic Materials” by J. H. Steigerwald, S. P. Murarka and R. J. Gutman, 1997) and generally known in the art. We note that “CMP” is also used in the art to denote “Chemical Mechanical Polishing” as well as “Chemical Mechanical Planarization”. We use CMP herein synonymously in either sense without distinction.

Current multi-layer IC fabrication typically makes use of tungsten CMP processes at each successive circuit level. Typically, blanket films of W are deposited on top of barrier layers of titanium (Ti) and titanium nitride (TiN). The films are then typically polished, thereby removing material resulting in (for example) W vias or “plugs” which are inlaid, typically in an SiO₂ dielectric layer. The W plugs act as electrically conducting paths between the metal lines of adjacent layers of the IC. Typically, the metal lines connected by W vias will consists of alloys of Al and Cu in present ICs. In typical present IC designs, Ti and TiN layers are used as barrier layers (to hinder unwanted diffusive intermixing of components during fabrication) and adhesion layers (to promote good bonding between otherwise poorly bound layers and to avoid delamination). Such barrier and adhesion layers must also be removed during W CMP to reveal the inlaid W plugs.

### BRIEF SUMMARY OF THE INVENTION

The present invention relates to slurry compositions for the chemical mechanical planarization (“CMP”) of tungsten as typically performed in the fabrication of integrated circuits. The present compositions are essentially free of dissolved, ionic metallic components and acheive high polishing rates for metal layers while reducing surface imperfections, metal recessing and/or dielectric oxide erosion. A non-metallic oxidizer in the form of periodic acid is used in combination with a mineral acid typically nitric acid, to maintain the pH of periodic acid at levels not leading to the precipitation of iodic acid salts. Ammonium nitrate (NH₄NO₃) is included in the CMP slurry which yields soft pad polishing rates of approximately 4,000 Å/min.

### DESCRIPTION OF THE DRAWINGS

FIG. 1: Schematic depiction of typical chemical mechanical planarization process.

### DETAILED DESCRIPTION OF THE INVENTION

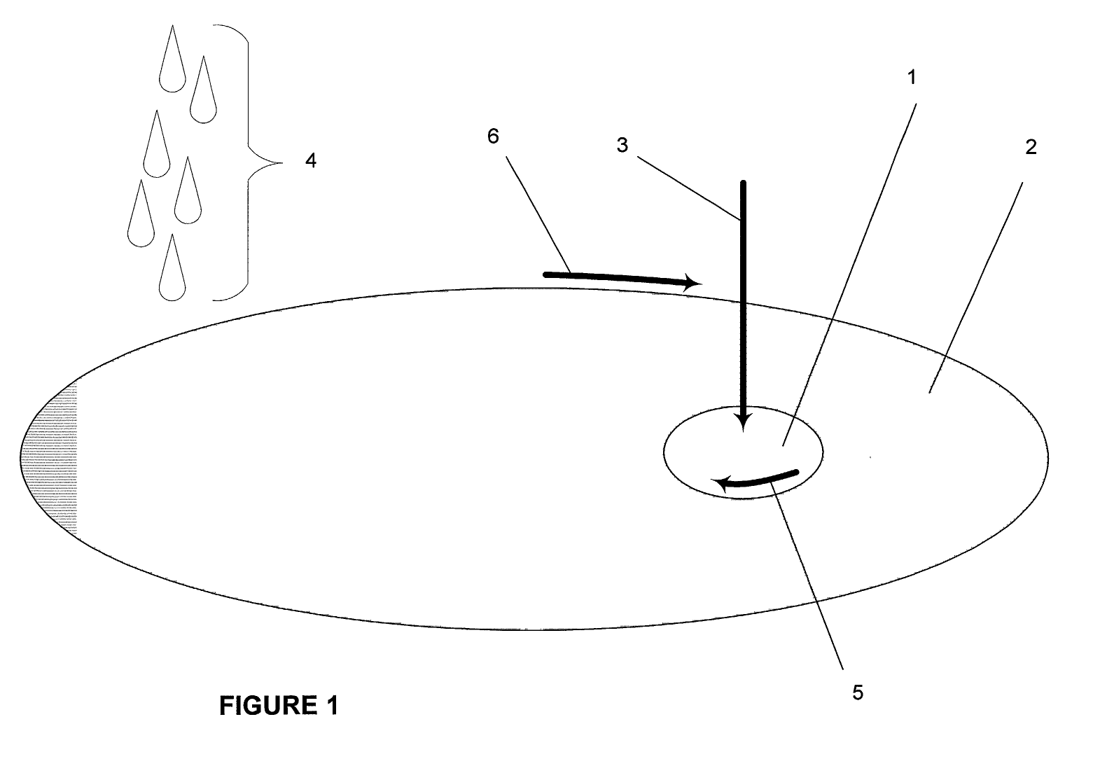

FIG. 1 is a schematic depiction of a typical chemical mechanical planarization (“CMP”) process. During CMP, a wafer to be planarized, 1, is typically held inside a rotating carrier (not shown in FIG. 1) and pressed onto a rotating polishing pad, 2, under an applied force, 3. An abrasive slurry, 4, is deposited onto polishing pad, 2, and flows between the wafer, 1, and pad, 2. Typically, abrasive slurry, 4, contains abrasive particles including SiO₂, Al₂O₃, among others. Slurry, 4, typically contains oxidizing agents or other reagents for chemically etching wafer, 1, in addition to abrasive particles, or in combination with the abrasives. Thus, in typical CMP, material is removed from the wafer by a combination of mechanical abrasion and chemical attack, leading to material removal and planarization.

Typically, the wafer, 1, will be caused to rotate as depicted by 5 in FIG. 1 while the polishing pad will itself rotate independently, 6 while in contact with the wafer Relative rotation of wafer and polishing pad provides both mechanical abrasion of material from the surface of the wafer, and delivery of etchant chemicals from slurry, 4, to the surface of the wafer. FIG. 1 depicts the wafer and pad rotating in the same direction, clockwise, when viewed from above, along the direction of 3. This is merely for purposes of illustration and counter-rotation of pad and wafer is also practiced. In addition to the rotations depicted in FIG. 1, the wafer and pad may undergo separately or concurrently oscillations in the plane of the surface being planarized, substantially perpendicular to the direction of applied force, 3.

The slurry composition is one of the important factors in the CMP process, typically including both abrasive particles and etchants in the form of oxidizing agents. Slurry compositions employing hydrogen peroxide (H₂O₂), a strong oxidizing agent, may cause recessing (“dishing”) in via or trench features as well as oxidation of the field oxide. Slurry compositions containing hydrogen peroxide tend to be unstable and have a short pot life.

In addition, abrasive particles as typically used in existing slurry compositions may introduce defects into the surface including microscratching and abrasive particles retained on the surface. The combination of microscratching and retained abrasive particles is known as “light point defects.” In particular, slurry compositions including Fe(NO₃)₃ tend to cause excessive microscratching of the surface up to depths of approximately 200 Angstroms (1 Angstrom=1 Å=10⁻⁸ cm). It is often necessary to remove microscratches by means of a separate polishing step following CMP. Also, slurries containing Fe(NO₃)₃ typically cause excessive staining of the CMP equipment.

An effective CMP process achieves both adequate surface planarization and adequate rate of material removal. That is, too low a rate of material removal is disadvantageous in that it lengthens the CMP process, reducing process throughput. However, in order to achieve effective material removal rates, CMP slurries containing either Fe(NO₃)₃ or hydrogen peroxide typically use a “hard” polishing pad. On the Shore scales for measuring hardness, typical hard pads as used herein have hardness values of Shore Durometer D (“Shore D”) typically greater than about 50. These hard pads typically achieve material removal rates of approximately 4,000 Å/min, or larger. Using such CMP compositions with a “soft” pad typically results in low rates of material removal, typically in the range from about 2,000 to approximately 3,000 Å/min. Such low rates of material removal are considered unacceptably low for practical CMP applications in a production environment.

Other slurry compositions contain weak oxidizing agents, such as KIO₃. However, such weak oxidizers typically result in rather low polishing rates. Thus, in polishing tungsten, the polishing step must be lengthened in order to remove essentially all of the tungsten layer. Lengthening of the polishing step may lead to over-polishing and undesirable erosion of other layers, such as silicon dioxide dielectric layers. Erosion of these layers typically makes it more difficult to print high-resolution features during subsequent photolithography steps, thereby increasing the number of wafer failures. This increase in polishing time reduces the throughput of the IC fabrication process, increasing unit costs for the resulting ICs.

Ferric nitrate-based CMP slurries currently in commercial use include relatively large concentrations of dissolved metallic compounds, which may range up to approximately 1%. As a result, the polished substrates tend to become contaminated by the adsorption into the interlayer region of the ICs of ionic species including metals. Migration of these ionic species changes the electrical properties of the IC, typically of gates and contacts, and also changes the dielectric properties of silicon dioxide or other dielectric materials. Therefore, it is desirable to expose the wafer to high purity chemicals having very low concentrations of metallic ions, less than approximately 0.1%. Non-metallic oxidizers do not result in migration problems but suffer from typically low polishing rates for tungsten, necessitating a lengthening of the polishing process and accompanying problems as noted above.

The present invention relates to a slurry composition that is essentially free of dissolved, ionic metallic components and is able to polish metal layers at effective, high polishing rates while reducing surface imperfections, metal recessing and/or dielectric oxide erosion. The present CMP slurry composition also reduces surface defects such as microscratching and/or light point defects.

A non-metallic oxidizer in the form of periodic acid is one example of an oxidizer used in connection with the present invention. Other examples include hydrogen peroxide, and potassium oxide, among others. Periodic acid is essentially free of dissolved, ionic metal compounds and, in contrast to ferric nitrate, is largely non-staining. Thus, the need for cleaning slurry material from CMP equipment and associated instrumentalities is significantly reduced. However, periodic acid does not typically achieve a high rate of removal of tungsten when used with a “soft” polishing pad. Furthermore, periodic acid solutions have a useful pH range from about 1.5 to 2.0 and is difficult to increase the pH of the solution since salts of iodic acid tend to participate at higher pH values. Such participates tend to cause excessive scratching of the surface and provide weaker oxidation capabilities than periodic acid.

The present invention makes use of an acid, typically nitric acid, to maintain the pH of periodic acid at levels not leading to the precipitation of iodic acid salts. Ammonium nitrate (NH₄NO₃) is included in the CMP slurry. Ammonium nitrate is a weak oxidizer having a pH of approximately 5. This composition results in a “soft” pad removal rate of tungsten of approximately 4,000 Å/min, or higher, and a “hard” pad removal rate of approximately 4,700 A/min or higher. These unexpected results are superior to the typical “soft” pad removal rates of approximately 3,000 Å/min and “hard” pad removal rates of 4,000 Å/min.

Abrasive Composition Components.

A typical abrasive slurry pursuant to some embodiments of the present invention includes alumina (Al₂O₃), a silica slurry (SiO₂), ammonium nitrate (NH₄NO₃), nitric acid (HNO₃), in aqueous solution, typically deionized (“DI”) water. Typical proportions for these component substances lie in the indicated ranges:

TABLE I

| Component | Weight Percent |
|---|---|
| 1) Alumina (Al₂O₃) | 2%-4% |
| 2) Silica (SiO₂) | 0.15%-0.30% |
| 3) Ammonium Nitrate | 0.8%-1.6% |
| 4) Nitric Acid | 0.02%-0.04% |
| 5) Periodic Acid | 2.0%-4.0% |
| 6) DI water | Remainder (approximately 90%-95%) |

Various substitutions, modifications and equivalent substances may be used in combination with the substances given in Table I, or in place of the substances given in Table I.

1) Alumina

In some embodiments, the alumina can be of the type which is manufactured by Balkowski Chemie and further processed by EKC Technology, Inc. and sold thereby under tradename MicroPlanar™ 3500/3010™. Details of these slurries are given in the Technical Data Sheet prepared by EKC Technology, Inc. and attached hereto as Attachment A. It is found that the alpha form of alumina does not perform as well in the present invention as do other forms of alumina, such as gamma alumina. Alumina can be replaced by spinel, silica, ceria or zirconia where, as used herein, spinel has the formula AO.Z₂O₃ where A is a divalent cation (for example, Mg), Z is at least one trivalent cation (for example, Al). Mixtures of the above-mentioned materials can also be used in the practice of the present invention.

2) Silica Slurry

One example of the silica slurry in Table I is manufactured by Dupont and sold under the name, DP 171. Data on this material is given in Attachment B. Typically, the row “%Solids . . . 29.0” appearing in Attachment B refers to % Solids (SiO₂). Silica slurry may be replaced by zirconia, alumina having particle sizes less than approximately 80 nm (nanometer), or ceria in a form having low removal for silicon dioxide rates (e. g. less than about 1000 Å/min), or mixtures of the aforesaid abrasives.

3) Ammonium Nitrate

Both ammonium ions and nitrate ions are important in the practice of the present invention. It is convenient to introduce ammonium and nitrate ions simultaneously in the form of NH₄NO₃. However, this is not an inherent limitation and ammonium and nitrate ions can be introduced via distinct molecules.

4) Nitric Acid

Nitric acid is used to maintain the pH of the abrasive composition at the desired value and to prevent the formation of salts of periodic acid. The abrasive composition typically has a pH in the range from approximately 3 to approximately 4.5 and, in some embodiments, from approximately 3.8 to approximately 4.2. Other mineral acids can be substituted for nitric acid, such as sulfuric acid among others.

5) Periodic Acid

A solution of periodic acid in DI water comprises one composition used in the practice of the present invention. In some embodiments, 100% periodic acid is mixed at a ratio of 10% by weight with DI water.

Preparation

Typically, the abrasive compositions of the present invention are prepared by adding the appropriate amount of alumina (Al₂O₃) to a prepared container of DI water or to a prepared container of DI water that has some or all of the nitric acid already added thereto. Initial addition of nitric acid to the DI water facilitates dispersion of alumina in the solution. This combination of the alumina (Al₂O₃), DI water and nitric acid is then milled. The silica slurry and ammonium nitrate are then added in any order. The result of the foregoing steps is an abrasive solution to be combined with a separately-prepared solution of periodic acid.

A periodic acid solution is prepared by adding periodic acid to a container of DI water. The container is preferably an opaque, unpigmented and plastic container such as polyethylene or polypropylene. Opacity tends to attenuate light reaching the periodic acid solution that may reduce the periodic acid into undesirable oxidation states.

The above abrasive solution is typically mixed with the above periodic acid solution and DI water in a ratio by volume of approximately 1:1:1.5. The final pH of the CMP polishing slurry prepared pursuant to the above procedure typically has a pH range from about 1.5 to about 2 and a preferred pH of about 1.7.

Polishing

A CMP solution was prepared having a composition as follows:

TABLE II

| Component | Weight Percent |
|---|---|
| 1) Alumina (Al₂O₃) | 3% |
| 2) Silica (SiO₂) | 0.25% |
| 3) Ammonium Nitrate | 1.2% |
| 4) Periodic Acid | 3% |
| 6) DI water | 92.55% |

CMP was performed employing an IPEC 472 polishing tool with settings that include a down pressure of 6 psi, a backpressure of zero, a platen speed of 90 RPMs a wafer carrier speed of 70 RPMs, and diamond pad conditioning ex-situ. The results obtained are as follows:

1. NH₄NO₃ was replaced with approximately the same molar percent (0.054 m) of KNO₃ and the pH of the slurry was retained at approximately 1.7. The tungsten “soft” pad removal rate was about 3,820 angstroms/minute.

2. NH₄NO₃ was replaced with approximately the same molar percent (0.054 m) of NH₄ClO₄ and the pH of the slurry was retained at approximately 1.7. The tungsten “soft” pad removal rate was about 3,620 angstroms/minute.

3. NH₄NO₃ at approximately a molar percent of 0.054 m gave a tungsten “soft” pad removal rate that was about 4,360 angstroms/minute.

Furthermore, absent the ammonium nitrate (NH₄NO₃), the remaining CMP polishing slurry pursuant to the present invention showed “soft” pad removal rates of about 3,200 angstroms/minute.

Hence, present invention provides a composition for tungsten chemical-mechanical planarization that can be used with a “soft” pad for keeping the polish defects to a minimum while retaining a high removal rate which is at least equal to or greater than 4,000 angstroms/minute and without employing a subsequent time-consuming buffing step.

Having described the invention in detail, those skilled in the art will appreciate that, given the present disclosure, modifications may be made to the invention without departing from the spirit of the inventive concept described herein. Therefore, it is not intended that the scope of the invention be limited to the specific and preferred embodiments illustrated and described.

What is claimed is:

1. A composition for the chemical mechanical planarization of tungsten comprising:
a) An abrasive selected from the group consisting of alumina, spinel, ceria, zirconia and mixtures thereof; and,
b) An abrasive slurry comprising at least one abrasive selected from the group consisting of silica, alumina, zirconia, ceria and mixtures thereof as a slurry in deionized water; and,
c) Periodic acid; and,
d) Ammonium nitrate; and,
e) A mineral acid in such quantity as to prevent the precipitation of salts of iodic acid.

2. A composition as in claim 1 wherein said abrasive is alumina.

3. A composition as in claim 2 wherein said alumina is form of alumina other than alpha alumina.

4. A composition as in claim 3 wherein said alumina is gamma alumina.

5. A composition as in claim 2 wherein said alumina is present in said composition in an amount from approximately 2% to approximately 4% by weight.

6. A composition as in claim 1 wherein said abrasive slurry is a silica slurry.

7. A composition as in claim 6 wherein said silica slurry is from approximately 0.1% to approximately 0.5% silicon dioxide.

8. A composition as in claim 1 wherein said periodic acid is present in said composition in an amount from approximately 2% to approximately 4% by weight.

9. A composition as in claim 1 wherein said ammonium nitrate is present in said composition in an amount from approximately 0.1% to approximately 2% by weight.

10. A composition as in claim 1 wherein said mineral acid is nitric acid.

11. A composition as in claim 10 wherein said nitric acid is present in said composition in an amount of 0.2% by weight.

12. A composition as in claim 1 wherein said mineral acid is present in said composition in an amount so as to maintain the pH of said composition in the range from approximately 3 to approximately 4.5.

13. A composition as in claim 12 wherein said mineral acid is present in said composition in an amount so as to maintain the pH of said composition in the range from approximately 3.8 to approximately 4.2.
